(19) United States
(12) Patent Application Publication
(10) Pub. No.: US 2003/0078970 A1
(43) Pub. Date: Apr. 24, 2003

(54) Interactive web conferencing

(76) Inventors: Ronald Leaders, Vashon, WA (US); Terri A. Lindow, Seattle, WA (US)

Correspondence Address: JENSEN + PUNTIGAM, P.S., SUITE 1020, 2033 6TH AVE, SEATTLE, WA, 98121, US

(21) Appl. No.: 10/043,565

(22) Filed: Oct. 18, 2001

(51) Int. Cl. G06F 15/16

(52) U.S. Cl. 709/204; 709/225

(57) ABSTRACT

A method of conducting an interactive electronic conference, including the steps of a) providing a registration process which initiates and provides access to the interactive program; b) polling participants and relaying the gathered geographic and professional information; c) introducing the experts and presenting the main program; d) inviting interactive questions or comments to restructure the program; and e) presenting conclusive remarks and providing follow up.

### TECHNICAL FIELD

This invention relates to interactive conferencing on the internet, wherein the conference host is able to interact visually on the screen, electronically by email, or vocally by telephone, or through the speakers integrated with the computer, with both a remote guest expert or experts and the remote participants. The method enables a participatory conference, which not only imparts information to a plurality of remote stations, but also is able to selectively change the course content and material delivered, depending upon the expressed interest of the participants. Multiple interactive presenters and experts permit different perspectives and solutions to be discussed for problems or challenges within the conference topic. An implementation tool related to the conference topic is provided to the participants and integrated into the presentation, thereby encouraging its immediate use by the participants into their own business practices.

### BACKGROUND OF THE INVENTION

Keeping employees current in how to deal with their particular problems or specialties, while keeping the cost reasonable has become an increasingly problematic situation. The employees typically either have to be transported to a location where the expert can share his knowledge or alternatively the expert has to be transported to a place where a group of targeted employees have gathered. The cost of this type of update including out-of-pocket and time consumption has become increasingly prohibitive, and therefore, often times an individual does not have the expertise necessary to perform their business task and responsibility effectively or in a timely manner.

Through the utilization of the computer and the internet it has become increasingly possible to provide expert information and updates to several remote locations requiring neither the host, the guest expert nor the participants themselves to travel, since the material can be transmitted to the desk top computer. Through the utilization of a pilot computer which can control the web browser of at least one passenger as disclosed in U.S. Pat. Nos. 5,944,791 granted to Scherpbier, Aug. 31, 1999 and 6,263,365 B1 granted to the same inventor, Jul. 17, 2001, enables the host to control the screens of the various individuals, making sure that all of them are identical, while also enabling two-way communication. The disclosure of these two references is incorporated herein. The communication may be delivered either verbally or electronically, to both poll the participants and tally the results, as well as relaying geographic locale information and pertinent questions to both maintain the interest of the participants and to specifically deal with the their particular issues.

### DISCLOSURE OF THE INVENTION

The present invention through the presentation and utilization of browser controller software, as described in the above-noted patents, permits a host to control the browser of remote participants through his computer keyboard and software, assuring that all participants are on the same web page, facilitating interaction and discussion. Further, the host is able to introduce and interact with a guest expert, likewise at a remote location, enabling the inexpensive participation of a group of participants, wherein each participant can be located at a separate remote terminal and have no other connection with the participants other then the electronic one, via the host.

### BRIEF DESCRIPTION OF THE DRAWINGS

FIG. 1 is a functional diagram of the present invention.

FIG. 2 is a schematic diagram showing a user display.

### BEST MODE FOR CARRYING OUT THE INVENTION

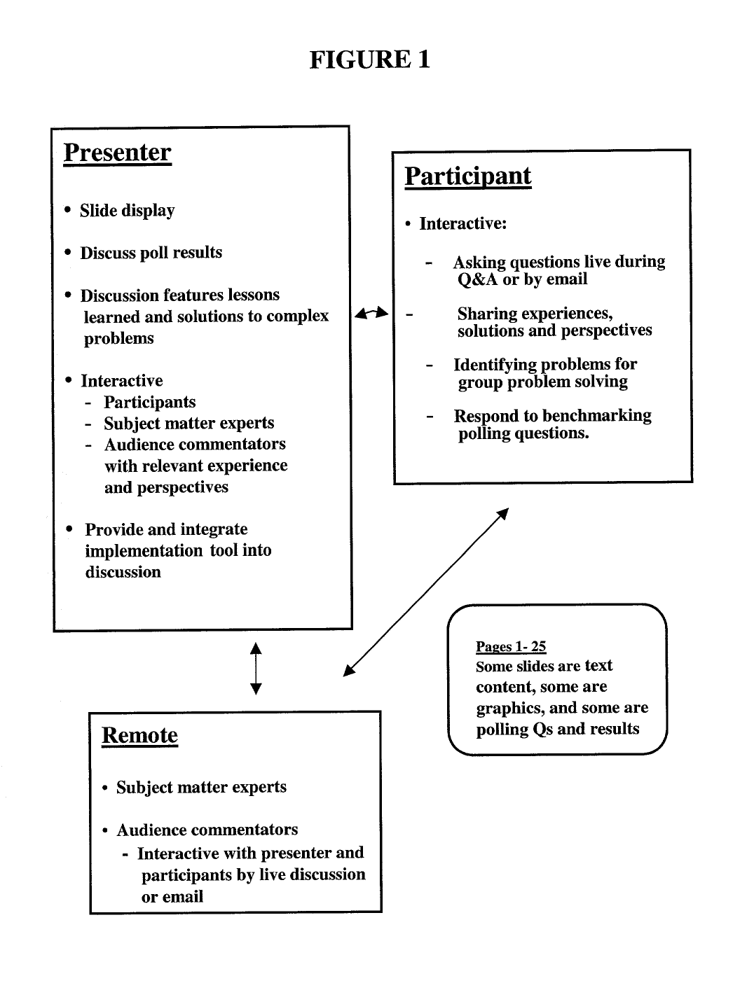

Schematically as seen in FIG. 1, the presenter, located generally at the site of the host machine, coordinates a slide display with the remarks of the expert, as well as instituting the polling questions and discussing the poll results. The presenter further institutes a discussion, which features lessons learned, and solutions to complex problems. The presenter is interactive with the participants, which are located at remote terminals, as well as the subject matters experts. The presenter also calls on audience commentators with relevant experience and perspectives, and provides and initiates the implementation tool into the discussion. As seen in the figure the presenter introduces the two-way interactive communication with one or more remote participant stations, which likewise communicate with subject matter experts enabling them to participate in the discussion. Likewise, pre-prepared audience commentators are interactive with the presenter and the participants by live discussions and/or email.

The participant block, which can be individual screens and/or in some conditions can be a multi-party screen, which are controlled by a presenter or host and is interactive with both the presenter host and the subject matter expert in that the participants can ask oral questions live or by email during the question and answer. These participants would be sharing an experience, solutions and their questions to assist in the overall presentation, as well as possibly altering the direction of the presentation in terms of significance for them. The participants will further participate by identifying problems for group problem solving and responding to benchmarking polling questions.

It is to be understood that the presenter host has a substantial amount of flexibility in the presentation and it is anticipated that the some of slides presented are topical content and some would be graphs, as well as some presenting the poll questions, as well as tabulating the results.

The presenter host would assume the administrative responsibilities of soliciting participation, handling the registration, assuring that all of the participants are present for the presentation and further coordinating with the subject matter expert. The presentation would normally be given during a lunch period or other normal down time for the participants. The presenter host would likewise follow-up with a summary of the presentation to be submitted to the participants, which summary can be used to enhance implementation of the conference content.

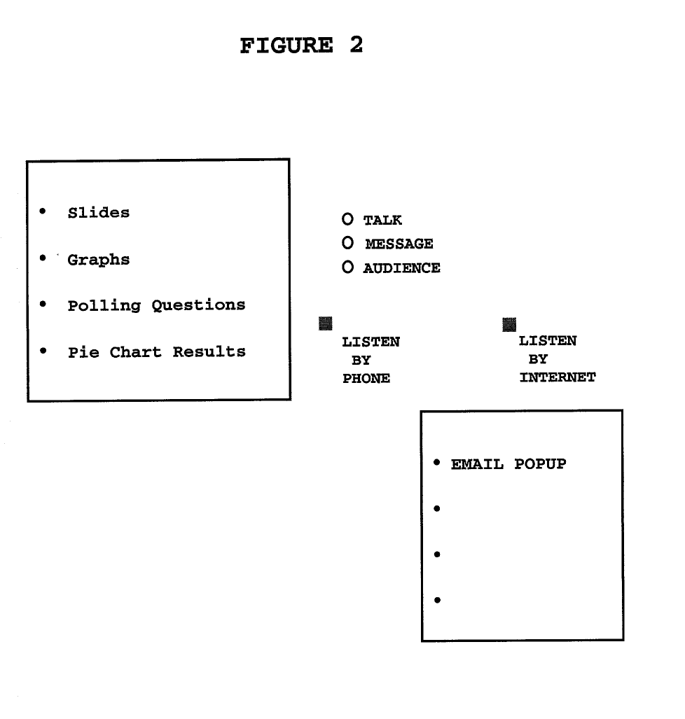

As seen in FIG. 2, the screen display, as seen by the participants includes a main screen upon the slide presentation is shown, the poll results and the audience geographic display are likewise displayed. Likewise seen on the monitors/screen is an onscreen task area wherein using the mouse control the participant can indicate to the presenter that he would like to talk, a caller would like to leave a message, would like to have indication of the geographic location of the audience, and further indicate that he would prefer to listen by phone, rather than the desk top speaker system. Likewise there is a place for typing a message to be sent to the presenter by email.

Thus as can be seen the present invention allows a presentation to be made to a plurality of remote locations, wherein each of the participants are interactive with both the presenter host and the topical expert and the task is accomplished economically for all involved.

1) A method of conducting an electronic conference, comprising:
providing a registration process;
providing access to interactive program on the internet;
polling participants,
relaying geographic and professional information; introducing experts;
presenting main program;
inviting interactive questions or comments from participants and electronic communication or open mike in order to restructure the program;
presenting conclusion, including introduction of follow-up implementation tool; and
providing follow-up support for implementation of conference subject into business practices.
